(19) United States
(12) Patent Application Publication
(10) Pub. No.: US 2026/0236774 A1
(43) Pub. Date: Aug. 13, 2026

(54) METHOD AND SYSTEM FOR GENERATING A SUBNETWORK DISTIRBUTION OF A DEEP NEURAL NETWORK

(71) Applicant: Embedl AB, Göteborg (SE)

(72) Inventors: Andreas Ask, Göteborg (SE); Daniel Ödman, Mölndal (SE); Hans Salomonsson, Öjersjö (SE); Ola Tiverman, Västra Frölunda (SE)

(21) Appl. No.: 19/160,633

(22) PCT Filed: Mar. 7, 2024
(86) PCT No.: PCT/SE2024/050211

§ 371 Date: Aug. 28, 2025

(30) Foreign Application Priority Data
Mar. 8, 2023 (SE) 2350256-0

(51) Int. Cl. G06N 3/082

(52) U.S. Cl. CPC G06N 3/082

(57) ABSTRACT

A computer implemented method of generating a subnetwork distribution of a deep neural network for a hardware system comprising a plurality of compute nodes the method comprising, in a processor device: receiving a deep neural network; receiving topology and performance information of the hardware system; receiving runtime statistics of the hardware system; receiving at least one target performance parameter for execution of the deep neural network on the hardware system; for each target performance parameter, dividing the deep neural network into at least one subnetwork distribution based on the runtime statistics of the hardware system and based on the target performance parameter. Each subnetwork in a subnetwork distribution is adapted to be executed on a compute node of the hardware system, and for each subnetwork distribution, determining a performance metric for at least one target performance parameter for execution of the deep neural network on the hardware system.

### FIELD OF THE INVENTION

The present invention relates to a method of generating a subnetwork distribution of a deep neural network. In particular, the invention relates to a method of dividing a deep neural network into a subnetwork distribution based on runtime statistics of a hardware system and system requirements.

### BACKGROUND OF THE INVENTION

Machine learning inference is defined as the process of running an input through a machine learning model and producing an output. The input can, e.g., be an image, and the output can be the model's prediction of what that image depicts. A model may for example be provided in the form of a deep neural network (DNN).

There is an increasing interest in using machine learning models in general and DNNs in particular in various applications such as embedded systems. However, due to the limited resources of embedded systems, many DNNs are too demanding to be executed directly on an embedded device or in an embedded system, and the inference is instead performed in the cloud where computations can be performed in powerful compute clusters.

Embedded systems, such as mobile phones and smart cameras, are often limited in terms of multiple resources: battery, computing speed, and memory. Driven by advances in, e.g., autonomous driving, embedded devices are becoming more and more powerful—some even have dedicated compute units specifically for DNN inference. As a result, distributing the computation to the cloud is sometimes no longer necessary.

It can now be beneficial to perform the computation of the DNN locally, as the extra latency of sending data to the cloud may outweigh any benefits of performing the computation remotely. Restrictions in terms of memory of an embedded system can be solved by stacking multiple devices together, where each device hosts part of the computation. Thus, once again negating the benefits of distributing to the cloud. This defines a new era, where embedded devices start to rival the power of central computers.

There are however still many challenges to overcome to be able to efficiently perform machine learning inference in embedded systems and further development is required. Accordingly, it is desirable to further develop methods for running a machine learning model in a system comprising a number of hardware resources such as an embedded system.

### SUMMARY

In view of above-mentioned and other drawbacks of the prior art, it is an object of the present invention to provide an improved method of generating a subnetwork distribution of a deep neural network for a hardware system comprising a plurality of compute nodes.

According to a first aspect of the invention, there is provided a computer implemented method of generating a subnetwork distribution of a deep neural network for a hardware system comprising a plurality of compute nodes. The method comprises, in a processor device: receiving a deep neural network; receiving topology and performance information of the hardware system; receiving runtime statistics of the hardware system; receiving at least one target performance parameter for execution of the deep neural network on the hardware system; for each target performance parameter, dividing the deep neural network into at least one subnetwork distribution based on the runtime statistics of the hardware system and based on the target performance parameter, wherein each subnetwork in a subnetwork distribution is adapted to be executed on a compute node of the hardware system, and for each subnetwork distribution, determining a performance metric for at least one target performance parameter for execution of the deep neural network on the hardware system.

The present invention is based on the realization that by dividing a deep neural network intended for execution on a hardware system based on known properties of the hardware resources and on runtime statistics of the hardware system, the inference of the deep neural network can be optimized for a selected performance parameter and for a given hardware system. Accordingly, runtime statistics are related to the hardware while the performance parameters are related to execution of a particular given deep neural network on a specific hardware system.

Moreover, the described method allows for local optimization with respect to a plurality of different performance parameters so that a suitable subnetwork distribution can be dynamically selected based on requirements and the runtime performance at the point in time when the deep neural network is executed on the hardware system.

A subnetwork distribution is in the present context described as a number of subnetworks together forming the deep neural network. The method involves dividing the deep neural network into a plurality of subnetworks where each subnetwork is configured to receive an input and to provide an output, i.e. an inference or a partial inference. An input may be received from another subnetwork or from a function of the hardware system in which the deep neural network is executed. It should be noted that depending on requirements, subnetwork distributions may exclude functionality of the complete deep neural network while still providing an inference. In other words, a subnetwork distribution does not need to include all features, functions and/or computations of the complete deep neural network.

Moreover, each unique division (distribution) of the deep neural network is seen as a separate subnetwork distribution. Accordingly, even if the number of subnetworks in two subnetwork distributions are the same, the distributions are seen as unique subnetwork distributions if the contents of the subnetworks differ.

That the hardware system comprises a plurality of compute nodes should be understood to mean that there is a plurality of hardware resources available for execution of subnetworks of the deep neural network. A compute node may for example be a single computer, one of several processors/accelerators on a PCB board, a digital signal processor (DSP) in a chip, a neural processing unit in a field programmable array (FGPA), a co-processor, an accelerator, etc. Moreover, a compute node may also be defined as a time slot on a processor device such that a single processor device can be described as a plurality of compute nodes depending on available time slots, or where each time slot is seen as a compute node, i.e. what can be referred to as time-slicing. A compute node can also be seen as a process run on a processing device such that a single processing device may comprise a plurality of compute nodes which can be utilized in parallel or at least independently. A compute node may also be one or more cores in a multi-core processing device.

The topology of the hardware system describes which hardware resources are available in the hardware system and also the connections between hardware resources. The deep neural network can thereby be divided based on knowledge not only of the properties of the compute nodes as such but also based on knowledge of properties of connections between compute nodes, thereby making it possible to adapt communication between subnetworks based on the known topology. Moreover, performance information of the hardware system can be seen as inherent properties of the hardware system.

The runtime statistics can either be generated by measurements on components and compute nodes of the hardware system in an initial benchmarking step where a deep neural network is executed by the hardware system, or part or all of the runtime statistics can be derived by simulating or in other ways estimating the performance of the hardware, e.g. using model based prediction. The runtime statistics can be collected and saved as a lookup table in a database, and/or it can be embedded in a simulation model or estimation model. Runtime statistics is advantageously collected from different configurations of a deep neural network so that the runtime statistics can be used to estimate how a modification of the deep neural network influence execution parameters of the network, i.e. performance parameters. From the runtime statistics, an optimization engine knows how changes to the deep neural network will impact target performance parameters described in the requirements. The optimization engine may be described as and/or include a performance predictor which can predict how modifications to a subnetwork distribution influence a performance parameter.

That the subnetwork is adapted to be executed on a compute node of the hardware system means that modifications to the deep neural network are performed so that the execution performance of a subnetwork on a compute node is improved. Such adaptation may for example include modifying operating parameters of the network such as the number of filters in a convolution operator. Adaptations can, for example, also include: reducing the kernel size of a convolution operation, removing one or several operations from the network, sparsify the network by inserting zeros in the networks weight tensors or in other way change the architecture in such a way that the performance improve on the hardware. Adaptation of the subnetwork thereby means both that split points between layers in the network may be changed and that the layers as such are reconfigured.

A performance metric describes a measured, simulated, or predicted performance for execution of the deep neural network on the hardware system, making it possible to compare the different subnetwork distributions for different performance parameters. A fundamental performance metric may for example be the total execution time of a subnetwork distribution. Other performance metrics may describe the energy consumption, memory usage or accuracy for the inference of the deep neural network. Moreover, the performance metrics may be defined for the whole hardware system, or for one or more individual compute nodes.

According to an example embodiment, performance information of the hardware system includes at least one of memory size of a compute node, memory availability of a compute node, time availability of a compute node, computational resources of a compute node, latency of a compute node, and latency between compute nodes. The memory availability and computational resources of a compute node may describe the amount of memory and computational resources of a specific compute node which is available for execution and/or storage of a subnetwork, and similarly, the time availability of a compute node may describe the size/duration of a time slot of a compute node or other means of resource sharing approaches. Moreover, a latency of a compute node describes the time it takes to perform certain operations and the latency between compute nodes may include both a response time of a node and the time required for transmitting the required amount of data between nodes. The performance information may also include computer node latency for different types of operations. Moreover, it should be noted that the received topology and performance information of the hardware system preferably only describes the resources available for execution of the deep neural network, and that the received performance information of the hardware system thereby does not have to include all resources or components of the hardware system. The performance information of the hardware system thereby describes the capabilities of the hardware system in terms of defined parameters directly linked to the hardware system. Even though some performance parameters can be determined or estimated from runtime statistics, the two are different since the runtime statistics are related to execution of a deep neural network on the hardware system.

According to an example embodiment, the target performance parameter is at least one of latency, energy consumption, runtime memory usage, data size of subnetwork when stored on compute node, number of computations for an inference (e.g. FLOPs), throughput, and accuracy. Thereby, the deep neural network is divided taking at least one target performance parameter in consideration together with the hardware system topology. An objective may for example be to perform the inference of the deep neural network as fast as possible, in which case the division into subnetworks is made aiming to optimize the latency, i.e. the total execution time, of the subnetwork distribution. An objective when forming subnetwork distribution may also comprise optimizing the subnetwork distribution with respect to several performance parameters, or to find a solution achieving an advantageous trade-off between different performance parameters. The performance parameter can be described on a system level, for individual compute nodes, or a combination of both. Throughput can here be described as the number of operations per time unit which for example can be improved by implementing parallel operations.

According to an example embodiment, dividing the deep neural network into a plurality of subnetworks comprises receiving a previous performance metric of the target performance parameter for a first subnetwork distribution executed on the hardware system; and dividing the deep neural network into a second subnetwork distribution based on runtime statistics describing performance of the hardware system such that the previous performance metric is improved. Accordingly, the described method is an iterative process where a first subnetwork distribution can be formed and tested for example through simulation to determine a performance metric. Based on the known runtime statistics, it can be anticipated how a change in a subnetwork distribution will affect the performance metric, and changes are thus not performed randomly but instead based on knowledge of the hardware system. An iterative optimization process can be performed until no further improvements of the performance metric can be found, or where any improvements are minor and/or detrimental to other performance parameters.

According to an example embodiment, the operation of dividing the deep neural network into at least one subnetwork distribution comprises: accessing a lookup table comprising runtime statistics; and for a target performance parameter, determine if a change in subnetwork distribution improves a performance metric for the performance parameter. The use of a lookup table offers an efficient way of determining how changes in a subnetwork distribution influences performance parameters. The lookup table may for example comprise information about the performance of the network components. For example, the network might have a convolution using a certain number of filters, and by consulting the lookup table it can be determined if the convolution would be faster using a different number of filters. An alternative to a lookup table is to measure the target performance parameters on the hardware system, using hardware simulators or predicting the target performance using performance predictor models. Measuring the performance parameters can be more accurate but is typically also more time consuming. Predictions may be efficient but also time consuming and/or have lower accuracy depending on the complexity of the model used.

According to an example embodiment, dividing the deep neural network comprises adapting a size of a subnetwork to not exceed an available storage space of corresponding compute node. Moreover, dividing the deep neural network comprises adapting operations of a subnetwork based on a runtime environment of a corresponding compute node. Different runtime environments have different properties and thereby may perform certain operations in different ways and with different latency and efficiency. The runtime environment may also set limitations on the amount of available runtime memory which is then taken into account when dividing the deep neural network. Accordingly, it is advantageous to form subnetworks with knowledge of the runtime environment of the compute node on which the subnetwork will be executed. Examples of runtime environments include NVIDIA TensorRT, ONNX Runtime, Tensorflow Lite and Arm NN.

According to an example embodiment of the invention dividing the deep neural network into at least one subnetwork distribution comprises pruning, performing neural architecture search (NAS) and/or performing quantization of the deep neural network and/or of its subnetworks. The aforementioned actions describe different ways of modifying a deep neural network, but also other methods may be used.

According to an example embodiment, the method further comprises: by the first processor device, providing the plurality of subnetworks to a scheduling node; by the scheduling node, receiving a target performance parameter; by the scheduling node, comparing the target performance parameter with corresponding performance metrics for the target performance parameter of the plurality of subnetwork distributions; and by the scheduling node, selecting the subnetwork distribution from the plurality of subnetwork distributions having the best performance metric for the received target performance parameter. The best performance metric is selected based on one or more target performance parameters. For example, if the target performance parameter is latency, the subnetwork having the lowest latency can be seen as the subnetwork distribution having the best performance metric. Analogously, if the target performance parameter is throughput, the subnetwork having the highest throughput can be seen as the subnetwork distribution having the best performance metric. Moreover, the best performance metric may also be the performance metric being closest above or belove a specific threshold for a given target performance parameter. An additional condition when selecting a subnetwork distribution may thus be that the selected performance metric is not allowed to be above or below a given threshold. A subnetwork distribution can also be optimized based on a combination of a plurality of target performance parameters, such as if an inference must be performed within a specified time period, but without consuming more than a given amount of energy.

The scheduling node is typically a component or compute node part of or arranged in connection with the hardware system. The scheduling node receives a plurality of subnetwork distributions along with performance metrics for different performance parameters for the corresponding subnetwork distributions so that when a request comes from the hardware system to execute the deep neural network, the scheduling node can select the subnetwork distribution best matching the current requirements of the hardware system.

According to a second aspect of the invention, there is further provided a computer system comprising processing circuitry configured to: receive a deep neural network; receive topology and performance information of the hardware system; receive runtime statistics of the hardware system; receive at least one target performance parameter for execution of the deep neural network on the hardware system; for each target performance parameter, divide the deep neural network into at least one subnetwork distribution based on the runtime statistics of the hardware system and based on the target performance parameter, wherein each subnetwork in a subnetwork distribution is adapted to be executed on a compute node of the hardware system, and for each subnetwork distribution, determine a performance metric for at least one target performance parameter for execution of the deep neural network on the hardware system.

Additional effects and features of the second aspect of the invention are largely analogous to those described above in connection with the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 is a flow chart outlining steps of a method according to example embodiments;

FIG. 2 schematically illustrates features of a system and method according to embodiments of the invention;

FIG. 3 schematically illustrates features of a system and method according to embodiments of the invention;

FIG. 4 schematically illustrates features of a system and method according to embodiments of the invention;

FIG. 5 schematically illustrates an example implementation of a system and method according to embodiments of the invention;

FIG. 6 schematically illustrates an example implementation of a system and method according to embodiments of the invention;

FIG. 7 schematically illustrates an example implementation of a system and method according to embodiments of the invention.

### DETAILED DESCRIPTION OF EXAMPLE EMBODIMENTS

In the present detailed description, various embodiments of the method and system according to the present invention will be described.

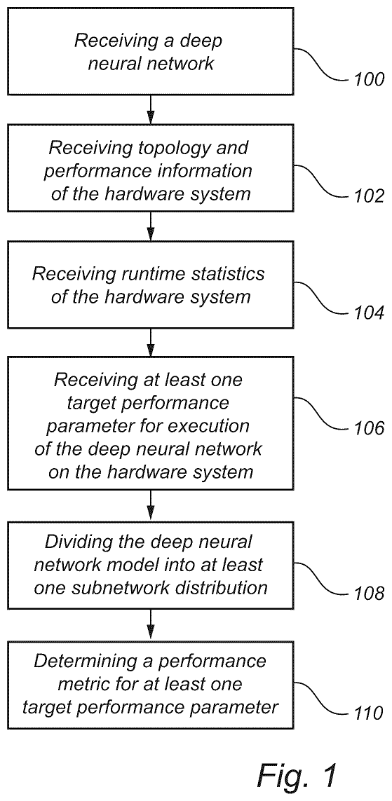

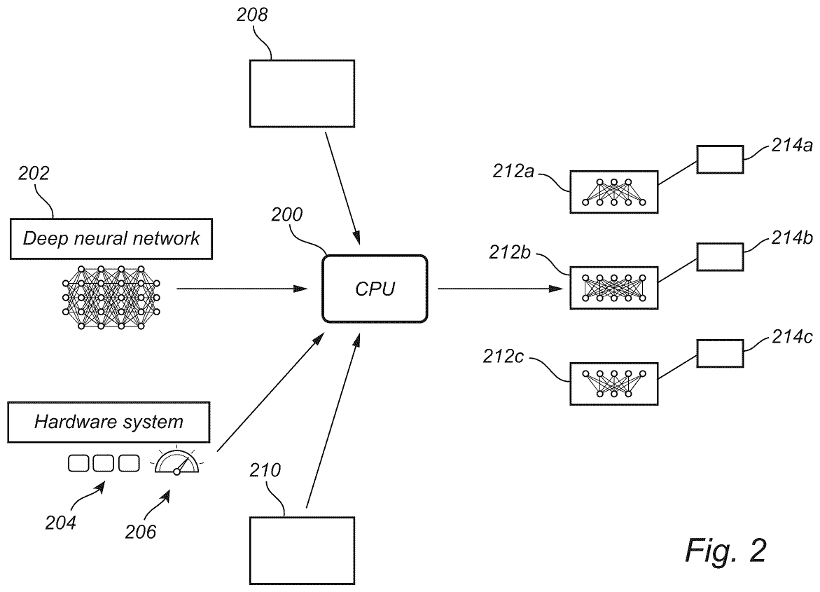

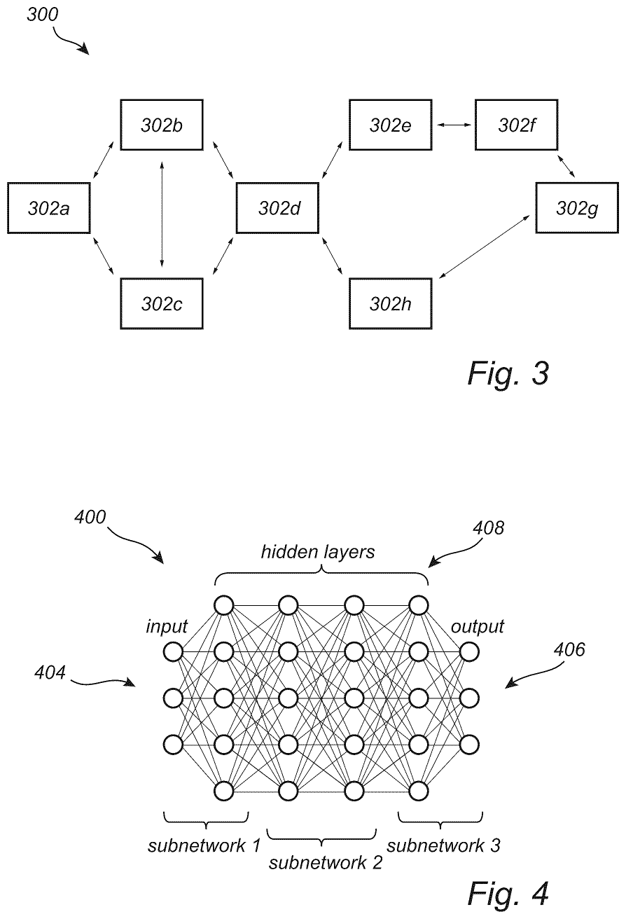

FIG. 1 is a flow chart outlining steps of a method of generating a subnetwork distribution of a deep neural network according to example embodiments and the method will be described with further reference to FIG. 2 schematically illustrating features of a system and method according to embodiments of the invention. Furthermore, FIG. 3 schematically illustrates a hardware system 300 comprising a plurality of compute nodes 302a-h on which the deep neural network will be executed. Each compute node represents a set of computing resources (CPU, RAM, HDD), which are tied to actual physical hardware. A compute node also includes the time availability of the resource. Thereby, a compute node can be defined by a specific set of hardware resources available for a specific period of time.

The computer implemented method of generating a subnetwork distribution of a deep neural network comprises, in a processor device 200 (CPU): receiving 100 a deep neural network 202; receiving 102 topology 204 and performance information 206 of the hardware system 300; receiving 104 runtime statistics 208 of the hardware system 300; receiving 106 at least one target performance parameter 210 for execution of the deep neural network on the hardware system 300; for each target performance parameter 210, dividing 108 the deep neural network into at least one subnetwork distribution 212a-c based on the runtime statistics 208 of the hardware system 300 and based on the target performance parameter 210, wherein each subnetwork in a subnetwork distribution is adapted to be executed on a compute node of the hardware system, and for each subnetwork distribution, determining 110 a performance metric 214a-c for at least one target performance parameter for execution of the deep neural network 202 on the hardware system 300.

The processor device 200 may include a microprocessor, microcontroller, programmable digital signal processor or another programmable device. The processor device may also, or instead, include an application specific integrated circuit, a programmable gate array or programmable array logic, a programmable logic device, or a digital signal processor. Where the processor device includes a programmable device such as the microprocessor, microcontroller or programmable digital signal processor mentioned above, the processor device may further include computer executable code that controls operation of the programmable device.

The processor device 200 may further include or be coupled to a non-transitory computer-readable storage medium such as a storage device, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device and other drives associated with computer-readable media and computer-usable media may provide non-volatile storage of data, data structures, computer-executable instructions, and the like.

The processor device may receive the described information from any device or service in communication with the processor device, such as an internal, external, or remote data storage, a cloud computing environment or the like. The skilled person readily realizes that the described method may be implemented in any suitable software environment where either manual or automated input can be used to initiate and perform the steps of the method.

As schematically illustrated in FIG. 2, each subnetwork distribution 212a-c is a unique division of the deep neural network. Even though each subnetwork distribution 212a-c in FIG. 2 has a unique topology, it should be noted that two unique subnetwork distributions may be distinguished by the type of operation performed in a given subnetwork, even if the division/topology of the two unique subnetwork distributions are the same.

Moreover, each subnetwork distribution 212a-c comprises at least one corresponding performance metric 214a-c so that based on a target performance parameter, the distribution with the best performance metric for the selected performance parameter can be selected. Performance information of the hardware system 300 includes at least one of memory size of a compute node, memory availability of a compute node, time availability of a compute node, latency of a compute node, and latency between compute nodes. A compute node may for example comprise a processor device having a known memory size and a known processing speed, where the memory size may be either or both of a static memory size and a dynamic memory availability. The performance information together with the topology of the hardware system 300 describing for example available connections between nodes provides information required for optimizing subnetworks for respective hardware nodes with respect to one or more target performance parameters including latency, energy consumption, memory requirement and accuracy. In practice, target performance parameters may be defined in many different ways and as combinations of target performance parameters. A target performance parameter may for example refer to a target for the execution of the deep neural network as a whole, such as a total energy efficiency or a total execution time, but it may also be possible to specify target performance parameters for individual compute nodes.

According to an example, dividing the deep neural network into a plurality of subnetworks comprises receiving a previous performance metric of the target performance parameter for a first subnetwork distribution executed on the hardware system; and dividing the deep neural network into a second subnetwork distribution based on runtime statistics describing performance of the hardware system such that the previous performance metric is improved. The method thereby involves an iterative approach for optimizing subnetwork distributions with respect to one or more performance parameters. An optimization procedure may also include specific desirable trade-offs between or weights of different performance parameters.

Dividing the deep neural network into at least one subnetwork distribution may also comprise accessing a lookup table comprising runtime statistics and for a target performance parameter, determine if a change in subnetwork distribution improves a performance metric for the performance parameter. A lookup table can thereby provide a fast and straightforward way of determining if a change in subnetwork distribution leads to an improvement in performance without having to simulate or perform an execution of the deep neural network.

Dividing the deep neural network may further comprise adapting a size of a subnetwork to not exceed an available storage space of corresponding compute node. Adapting the size may comprise operations such as pruning to remove parts of the deep neural network which may not be required for a given application, and also conventional compression which may be part of generating the subnetworks, but which may also be performed by compute nodes before transmission of a data package to a subsequent compute node. Operations of a subnetwork may also be modified based on a runtime environment of a corresponding compute node.

Furthermore, dividing the deep neural network into at least one subnetwork distribution may comprise performing neural architecture search (NAS) and/or performing quantization of the deep neural network. The subnetwork distributions may also be generated based on serial execution, parallel execution, or a combination thereof.

According to an example embodiment the method further comprises: by the first processor device, providing the plurality of subnetworks to a scheduling node; by the scheduling node, receiving a target performance parameter; by the scheduling node, comparing the target performance parameter with corresponding performance metrics for the target performance parameter of the plurality of subnetwork distributions; and by the scheduling node, selecting the subnetwork distribution from the plurality of subnetwork distributions having the best performance metric for the received target performance parameter. Accordingly, the scheduling node may be any one of the nodes 302a-h of the hardware system 300. The scheduling node may also be a separate compute node separate from the hardware system as such.

In an exemplifying scenario, the target performance parameter may be a total execution time. The scheduling node will then receive a request to execute the deep neural network and the execution resulting in an inference should be completed within the requested total execution time. The scheduling node will then turn to the performance metric “total execution time” for the different subnetwork distributions and select the subnetwork distribution having the lowest total execution time. The selected subnetwork distribution will subsequently be launched on compute nodes of the hardware system.

A request to the scheduling node may also comprise several target performance parameters such as execution time and memory consumption where the different performance parameters may be given different weight or priority. Accordingly, the scheduling node can take several different performance metrics into account when selecting a subnetwork distribution.

Depending on the selected target performance parameter, the scheduling node may also select different compute nodes. A first compute node 1 may have a lower processing speed and a larger memory size while a second compute node 2 has a higher processing speed and smaller memory size, thereby influencing the selection of a subnetwork distribution by the scheduling node.

FIG. 4 schematically illustrates an example subnetwork distribution 400 comprising three subnetworks 402a-c, and where each subnetwork 402a-c in turn comprises a plurality of operations to be performed by the respective subnetwork 402a-c. The subnetwork distribution 400 comprises an input portion 404 where the required input for the inference is provided to the deep neural network, an output portion 406 where the resulting inference of the deep neural network is provided, and a hidden portion 408 comprising hidden layers where operations are performed which are not directly visible or available to the end user.

In the following, four example scenarios 1-4 will be described where different parameters influence the division of the deep neural network into subnetwork distributions.

### Scenario 1

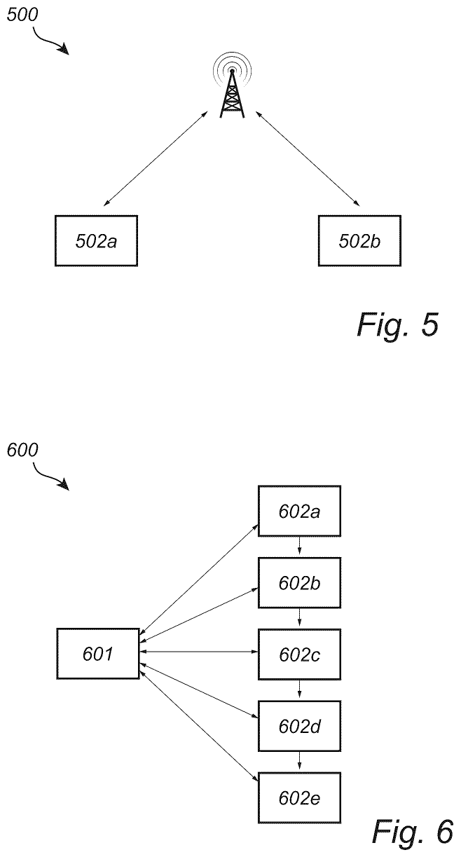

FIG. 5 schematically illustrates a hardware system 500 comprising two compute nodes 502 a-b communicating with each other via 5G. The full inference has latency as a target performance parameter. The subnetwork distribution can be generated in anticipation of a scenario where the first node 502a is the node responsible for taking action based on the output from the inference, but the first node 502a cannot fulfill the latency requirement alone. The deep neural network is thereby divided into two subnetworks, where the output of the first subnetwork is transmitted from the first node 502a to the second node 502b and used as input to the second subnetwork. Based on a latency imposed by transmitting the data from the first node 502a to the second node 502b, it can be determined that the inference does not fulfill the latency requirement without modifications to an initial subnetwork distribution. By modifying the architecture of the two subnetworks, e.g., via pruning, taking information about the hardware situated at the nodes and the chosen runtime environment into account, the latency requirement can be satisfied. The latency of the inference can be further reduced by modifying the first network such that the size of data that has to be transmitted between the two nodes 502a-b is reduced. Several subnetwork distributions and optimizations with respect to latency can be considered when dividing the deep neural network into subnetwork distributions, in order to find the best tradeoff between performance and latency.

### Scenario 2

FIG. 6 schematically illustrates a hardware system 600 comprising a central compute node 601 connected to a plurality of compute nodes 602a-e, where the compute nodes 602a-e are able to at least communicate serially. The illustrated hardware system 600 can be seen as representing a hardware system comprising several memory restricted compute nodes, where neither node can host the entire deep neural network by itself. The deep neural network is then partitioned into a distribution of subnetworks where each subnetwork fulfills the memory restriction of each respective node 602a-e. Each subnetwork can be further optimized in order to address any additional latency restriction of the full inference.

### Scenario 3

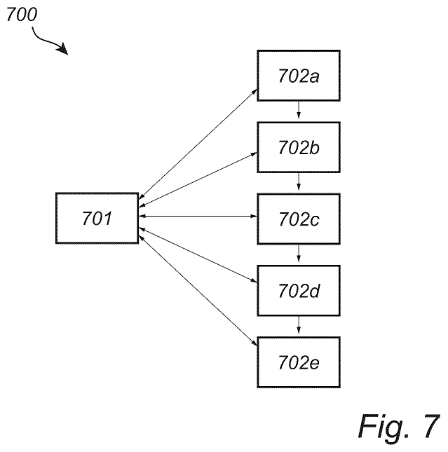

FIG. 7 schematically illustrates a hardware system 700 comprising a central compute node 701 connected to a plurality of compute nodes 702a-e, FIG. 7 represents a hardware system where the full inference of the deep neural network cannot be completed during a single available time slot, where the compute nodes 702a-e represent time slots on a single processing device. The deep neural network is then divided into a subnetwork distribution where the inference latency of each subnetwork does not exceed the corresponding available time slot 702a-e, which can be referred to as time-slicing. Each subnetwork can be further optimized in order to reduce the overall latency of the full inference.

Even though the invention has been described with reference to specific exemplifying embodiments thereof, many different alterations, modifications and the like will become apparent for those skilled in the art. Also, it should be noted that parts of the method and system may be omitted, interchanged or arranged in various ways, the method and system yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A computer implemented method of generating at least one subnetwork distribution and determining a performance metric of a deep neural network for a hardware system comprising a plurality of compute nodes, the method comprising, in a processor device:
receiving a deep neural network;
receiving topology and performance information of the hardware system;
receiving runtime statistics of the hardware system;
receiving at least one target performance parameter for execution of the deep neural network on the hardware system;
for each target performance parameter, dividing the deep neural network into at least one subnetwork distribution based on the runtime statistics of the hardware system and based on the target performance parameter, wherein each subnetwork in a subnetwork distribution is adapted to be executed on a compute node of the hardware system, and
for each subnetwork distribution, determining a performance metric for at least one target performance parameter for execution of the deep neural network on the hardware system.

2. The computer implemented method according to claim 1, wherein performance information of the hardware system includes at least one of memory size of a compute node, memory availability of a compute node, time availability of a compute node, computational resources of a compute node, latency of a compute node, and latency between compute nodes.

3. The method according to claim 1, wherein the target performance parameter is at least one of latency, energy consumption, number of computations for an inference, memory requirement, throughput and accuracy.

4. The method according to claim 1, wherein dividing the deep neural network into a plurality of subnetworks comprises:
receiving a previous performance metric of the target performance parameter for a first subnetwork distribution executed on the hardware system; and
dividing the deep neural network into a second subnetwork distribution based on runtime statistics describing performance of the hardware system such that the previous performance metric is improved.

5. The method according to claims 1, wherein the operation of dividing the deep neural network into at least one subnetwork distribution comprises:
accessing a lookup table comprising runtime statistics;
for a target performance parameter, determine if a change in subnetwork distribution improves a performance metric for the performance parameter.

6. The method according to claims 1, wherein dividing the deep neural network comprises adapting a size of a subnetwork to not exceed an available storage space of corresponding compute node.

7. The method according to claims 1, wherein dividing the deep neural network comprises adapting operations of a subnetwork based on a runtime environment of a corresponding compute node.

8. The method according to claims 1, wherein dividing the deep neural network into at least one subnetwork distribution comprises pruning, performing neural architecture search (NAS), performing quantization of the deep neural network and/or of the subnetworks.

9. The method according to claims 1, further comprising:
by the first processor device, providing the plurality of subnetworks to a scheduling node;
by the scheduling node, receiving a target performance parameter;
by the scheduling node, comparing the target performance parameter with corresponding performance metrics for the target performance parameter of the plurality of subnetwork distributions; and
by the scheduling node, selecting the subnetwork distribution from the plurality of subnetwork distributions having the “best” performance metric for the received target performance parameter.

10. A computer program product comprising program code for performing, when executed by the processing device, the method of claim 1.

11. A computer system comprising processing circuitry configured to:
receive a deep neural network;
receive topology and performance information of the hardware system;
receive runtime statistics of the hardware system;
receive at least one target performance parameter for execution of the deep neural network on the hardware system;
for each target performance parameter, divide the deep neural network into at least one subnetwork distribution based on the runtime statistics of the hardware system and based on the target performance parameter, wherein each subnetwork in a subnetwork distribution is adapted to be executed on a compute node of the hardware system, and
for each subnetwork distribution, determine a performance metric for at least one target performance parameter for execution of the deep neural network on the hardware system.

12. The computer system according to claim 11, wherein dividing the deep neural network into a plurality of subnetworks comprises:
receiving a previous performance metric of the target performance parameter for a first subnetwork distribution executed on the hardware system; and
dividing the deep neural network into a second subnetwork distribution based on runtime statistics describing performance of the hardware system such that the previous performance metric is improved.

13. The computer system according to claim 11, wherein the operation of dividing the deep neural network into at least one subnetwork distribution comprises:
accessing a lookup table comprising runtime statistics;
for a target performance parameter, determine if a change in subnetwork distribution improves a performance metric for the performance parameter.

14. The computer system according to claim 11, wherein dividing the deep neural network comprises adapting a size of a subnetwork to not exceed an available storage space of corresponding compute node.

15. The computer system according to claim 11 further comprising a scheduling device configured to:
receive the plurality of subnetworks from the processor device;
receive a target performance parameter;
compare the target performance parameter with corresponding performance metrics for the target performance parameter of the plurality of subnetwork distributions; and
select the subnetwork distribution from the plurality of subnetwork distributions having the best performance metric for the received target performance parameter.
